(19) United States
(12) Patent Application Publication
(10) Pub. No.: US 2004/0189604 A1
(43) Pub. Date: Sep. 30, 2004

(54) Computer mouse with ornamental light source

(76) Inventor: Vincent K. Lee, Taipei (TW)

Correspondence Address: DENNISON, SCHULTZ & DOUGHERTY, 612 Crystal Square 4, 1745 Jefferson Davis Highway, Arlington, VA, 22202-3417, US

(21) Appl. No.: 10/689,049

(22) Filed: Oct. 21, 2003

(30) Foreign Application Priority Data
Mar. 26, 2003 (TW) 092204669

(51) Int. Cl. G09G 5/08

(52) U.S. Cl. 345/163

(57) ABSTRACT

A computer mouse comprises a main housing, at least one button mounted on the main housing, and an electrical mechanism mounted inside the main housing to provide the basic functionality of a computer mouse. The improvement of the present invention comprises an ornamental light source member that is connected to the electrical mechanism for obtaining electrical power. The ornamental light source member can transmit light to produce an ornamental effect for the computer mouse.

### BACKGROUND OF THE INVENTION

1. Field of the Invention

The present invention relates to a computer mouse that is capable of radiating light to show different words or patterns.

2. Description of the Related Art

The computer mouse is a well-known and well-developed product, and therefore new product lines mainly have simply a new look (including color changes) to attract consumers.

In other words, by adding some interesting feature to the design of a computer mouse, it is possible to attract more buyers. An example of this is U.S. Pat. No. 6380926 (China utility patent No. ZL009250364.6), which combines a liquid decoration with a mouse.

### SUMMARY OF THE INVENTION

A main objective of the present invention is to provide a computer mouse with at least one ornamental light source.

Another objective of the present invention is to provide a computer mouse that has at least one ornamental light source to transmit words or patterns for different purposes (for example, for advertisements or purposes of fashion).

In order to achieve the above mentioned objectives, a computer mouse of the present invention includes a main housing, at least one button mounted on the main housing, and an electrical mechanism mounted inside the main housing to provide the basic functionality of a computer mouse. The present invention computer mouse is characterized in that the computer mouse has an ornamental light source member that is connected with the electrical mechanism to obtain electrical power, and the ornamental light source member transmits light to produce an ornamental effect for the computer mouse.

The ornamental light source can be designed to match up with an ornamental housing, or optical fiber can be used to produce an ornamental effect. When using the optical fiber to provide an ornamental effect, a cover with a plurality of holes can be used to arrange the optical fibers to form words or patterns.

Other objects, advantages, and novel features of the invention will become more apparent from the following detailed description when taken in conjunction with the accompanying drawings.

### BRIEF DESCRIPTION OF THE DRAWINGS

FIG. 1 is a lateral view of a first embodiment of the present invention.

FIG. 2 is a three-dimensional drawing with a portion of internal view of the first embodiment of the present invention.

FIG. 3 is a three-dimensional drawing of a second embodiment of the present invention, which shows a computer mouse with a liquid decoration.

FIG. 4 is a three-dimensional drawing of a third embodiment of the present invention, which shows a computer mouse utilizing a plurality of optical fibers.

FIG. 5 is a three-dimensional drawing of a fourth embodiment of the present invention, which shows a cover with a plurality of optical fibers and a plurality of holes.

FIG. 6 presents schematically a combining method of the optical fibers and the cover in the fourth embodiment.

FIG. 7 is a three-dimensional drawing of the fourth embodiment of the present invention, which shows optical fiber arranged to form writing or a pattern.

FIG. 8 is a three-dimensional drawing of a fifth embodiment of the present invention, which shows a cover with optical fiber and corresponding holes.

FIG. 9 presents schematically a combining method for the optical fiber and the cover in the fourth embodiment. FIG. 9A and FIG. 9B present schematically the computer mouse of the fifth embodiment transmitting different words or patterns at different times.

FIG. 10 is a three-dimensional drawing of a sixth embodiment of the present invention, which shows a computer mouse with optical fiber and an ornamental housing.

FIG. 11 is a three-dimensional drawing of a seventh embodiment of the present invention, which shows a computer mouse with a luminescent plate and an ornamental housing.

FIG. 12 is a three-dimensional drawing of an eighth embodiment of the present invention, which shows a computer mouse with a luminescent plate

FIG. 13 is a three-dimensional drawing of a ninth embodiment of the present invention, which shows words and patterns displayed on a transparent plate through light refraction.

FIG. 14 is a cross-section view, which shows a portion of a transparent plate with a plurality of holes and a light shield.

FIG. 15 is a cross-section view, similar to the FIG. 14 but with a mask mounted on the transparent plate.

### DETAILED DESCRIPTION OF THE PREFERRED EMBODIMENT

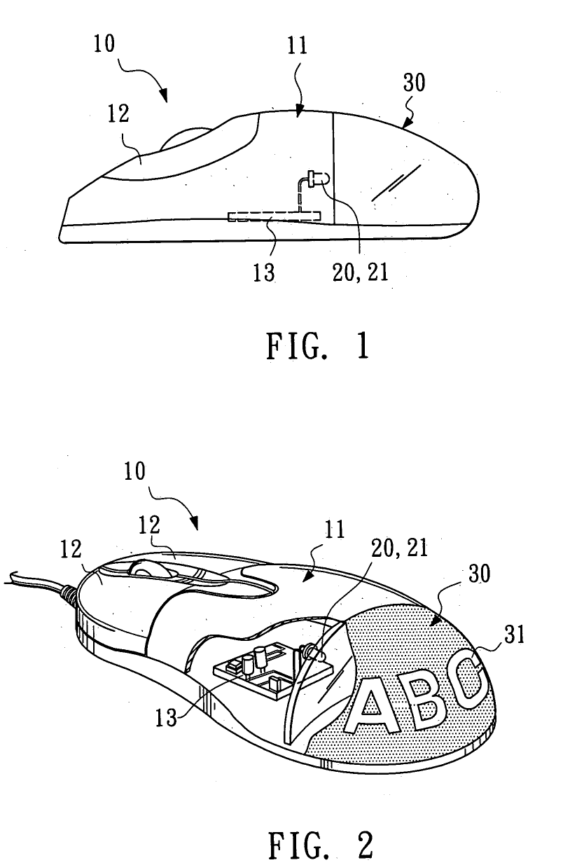

Please refer to FIG. 1 and FIG. 2 for the first embodiment of the present invention. A computer mouse 10 of the present invention has the basic functionality and structure of the prior art computer mouse. The computer mouse 10 has a main housing 11 (typically composed of two shells), at least one button 12 mounted on the main housing 11, an electrical mechanism 13 placed inside the main housing to provide basic functionality of the computer mouse 10 (such as sending controlling signals to control a computer cursor). Since the main characteristic of the present invention is not to improve the electronic or mechanical operation of the computer mouse, there will be no more detailed description of the electronics or mechanical structure of the computer mouse.

The computer mouse 10 of the present invention has at least one ornamental light source 20, such as a light emitting diode (LED) 21. The LED 21 is connected to the electrical mechanism 13 to obtain power (if the computer mouse is connected to a computer via a cable, the power will be provided by the computer; if the computer mouse is wireless, the power will be provided by a battery in the computer mouse). To be noted is that, although an optical computer mouse may also have an internal LED, such an LED is used for checking movement of the computer mouse and not for decoration.

Furthermore, an ornamental housing 30 is connected to the main housing 11. In this embodiment, the ornamental housing 30 has a word “ABC” thereon, and the word “ABC” is placed on a transparent or translucent area 31 so that the light transmitted from the LED 21 will cause the character “ABC” to radiate light. Of course, the word “ABC” can be changed to any other pattern, such as a trademark pattern. In order to transmit the light properly, the ornamental housing 30 should have at least one transparent or translucent area 31. Furthermore, the ornamental housing 30 can be a part of the main housing 11 or an independent housing connected to the main housing 11 by insertion or adhesion onto the main housing 11.

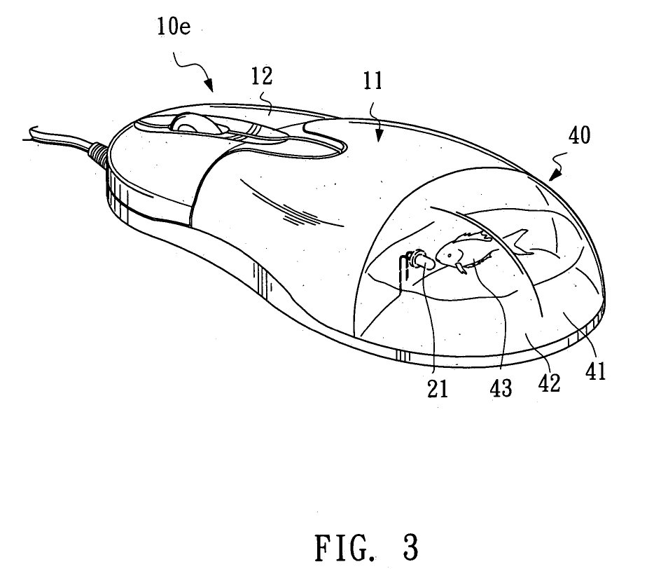

Please refer to FIG. 3. FIG. 3 is a three-dimensional drawing of a second embodiment of the present invention, which shows a computer mouse with a liquid decoration. A computer mouse 10a further comprises a liquid decoration 40 connected to the main housing 11. The liquid decoration 40 has a sealed vessel 41, and the sealed vessel 41 includes a liquid 42 and at least one float 43 in the liquid 42. The liquid decoration 40 is a well-known product; please refer to U.S. Pat. No. 6380926 (China new type patent No. ZL00250364.6). A main character of the second embodiment of the present invention is that by using the LED 21 to illuminate the liquid decoration 40. Moreover, the sealed vessel 41 had better to have a fluorescent material (such as phosphor) so the liquid decoration 40 will display different illumination characteristics.

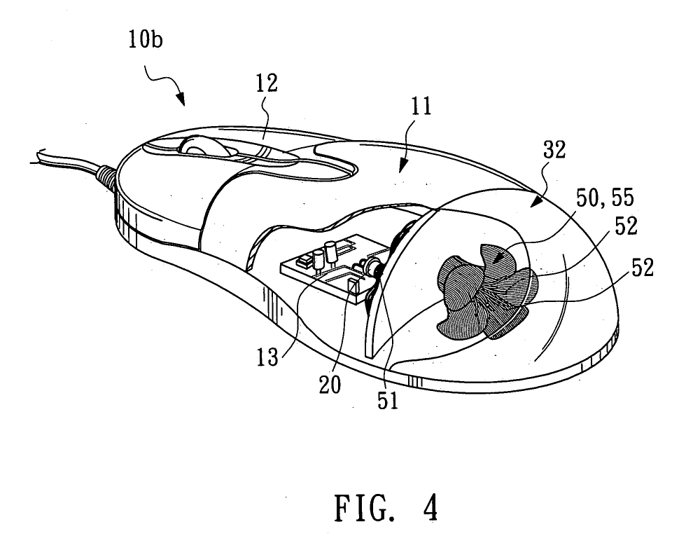

Please refer to FIG. 4. FIG. 4 is a three-dimensional drawing of a third embodiment of the present invention, which shows a computer mouse with a plurality of optical fibers. A computer mouse 10b comprises an optical fiber bundle 55 composed of the plurality of optical fibers 50. A transparent housing 32 is placed above the bundle 55 and connected to the main housing 11 by insertion or adhesion onto the main housing 11. Each optical fiber 50 has a front end 51 and a back end 52. All the front ends of the optical fibers 50 are connected to the ornamental light source 20 (such as an LED) so that the light from the ornamental light source 20 will be sent to the back ends 52 of the optical fibers 50.

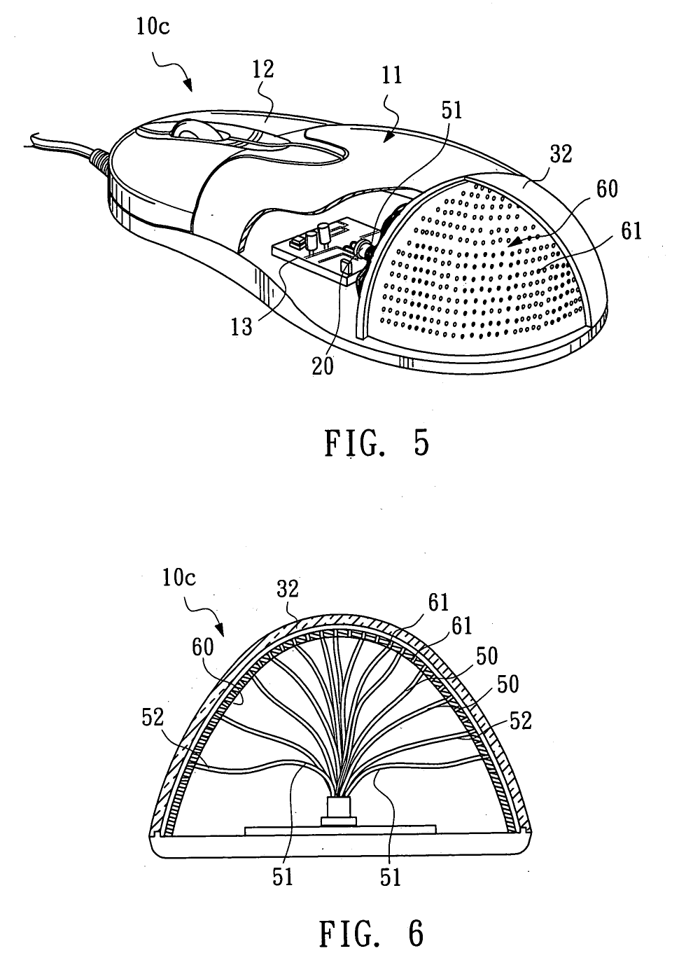

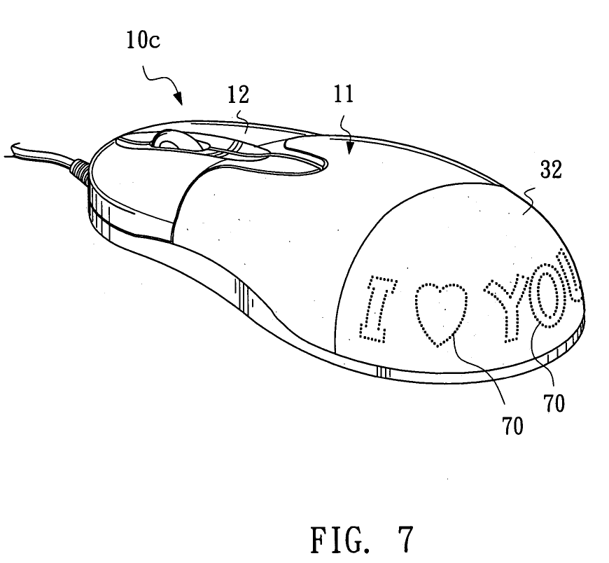

Please refer to FIG. 5 to FIG. 7 for the fourth embodiment. The difference between the third embodiment and the fourth embodiment is, in this embodiment, a computer mouse 10c has a cover 60 with a plurality of holes 61, and part or all of the back ends of the plurality of optical fibers are inserted through the holes 61. A diameter of the hole 61 is identical with a diameter of the optical fiber 50 so the optical fiber 50 is tightly inserted through the holes 61. The holes 61 on the cover 60 can be arranged to form a word or a pattern, for example, in this embodiment the holes 61 are arranged to form a pattern “IΦU”. In this embodiment, a user can insert the optical fibers 50 through the holes 61 and form a new character or a new pattern by himself or herself. In addition, a transparent housing 32 can be connected to the main housing 11 to protect the cover 60.

One thing. to be noted is that the plurality of holes 61 in the third embodiment and the fourth embodiment can be placed at predetermined positions to form a word or a pattern.

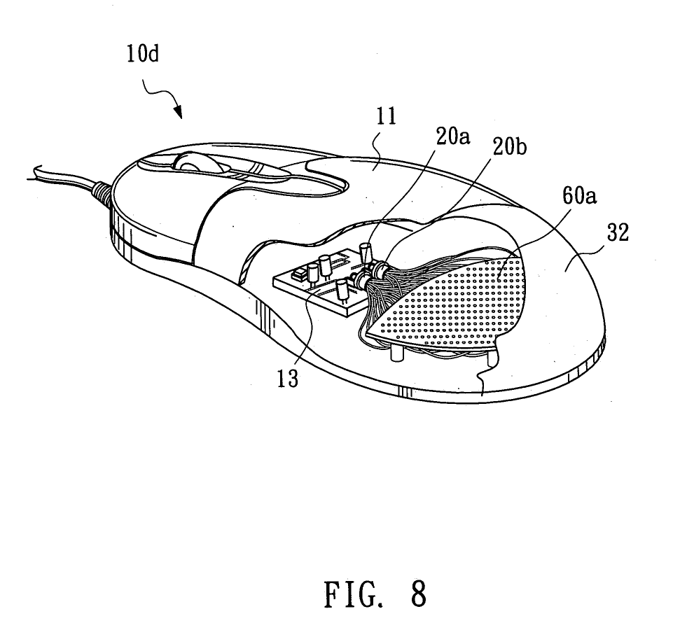

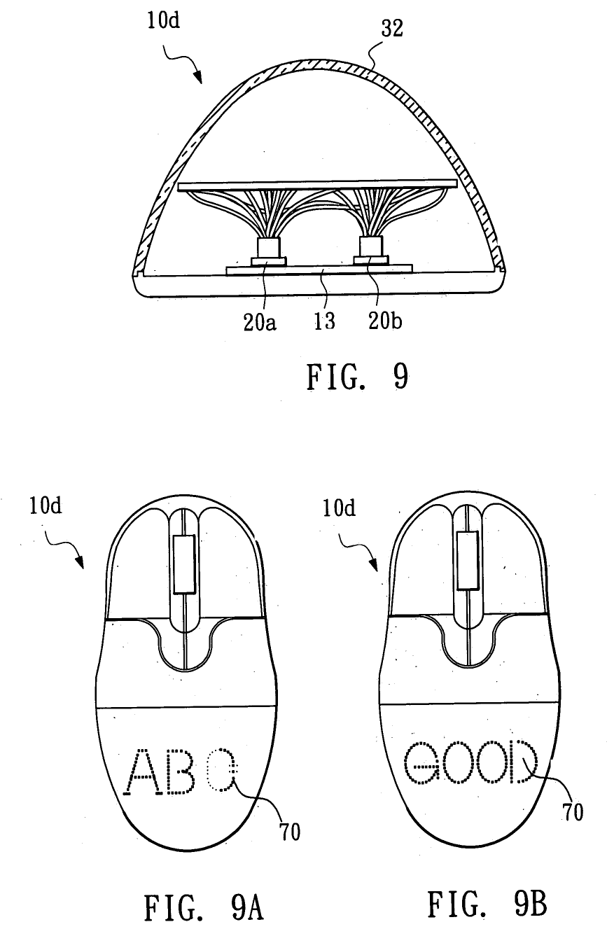

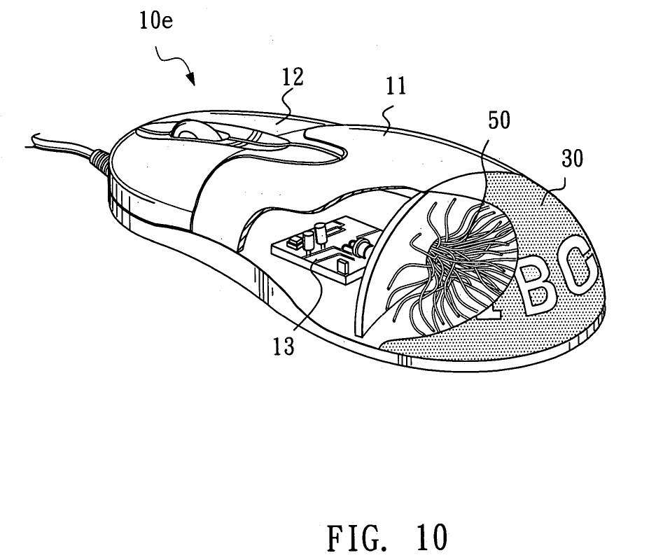

Please refer to FIG. 8 to FIG. 9 for the fifth embodiment. The difference between the fourth embodiment and the fifth embodiment is that a cover 60a of a computer mouse 10d is placed at a different position than the cover 60 of the computer mouse 10c, and the cover 60a is planar. However, the cover 60a works just as the cover 60 in the fourth embodiment. Furthermore, two ornamental light sources 20a, 20b with different colored lights are provided so that the arranged words and pattern are illumined in two different colors. For example, the two ornamental light sources 20a, 20b provide light in turn, and the ornamental light source 20a transmits light through the cover 60a to form the word “ABC” (shown in FIG. 9A), and the ornamental light source 20b transmits light through the cover 60a to form the word “GOOD” (as shown in FIG. 9B); the two words “ABC” and “GOOD” are thus shown in turn, or maybe even some other pattern 70.

Please refer to FIG. 10. FIG. 10 is a three-dimensional drawing of a sixth embodiment of the present invention, which shows the computer mouse with optical fiber and an ornamental housing. In the embodiment, a computer mouse 10d has the plurality of optical fibers 50 but not in any particularly arrangement, and the ornamental housing 30 shown in FIG. 2).

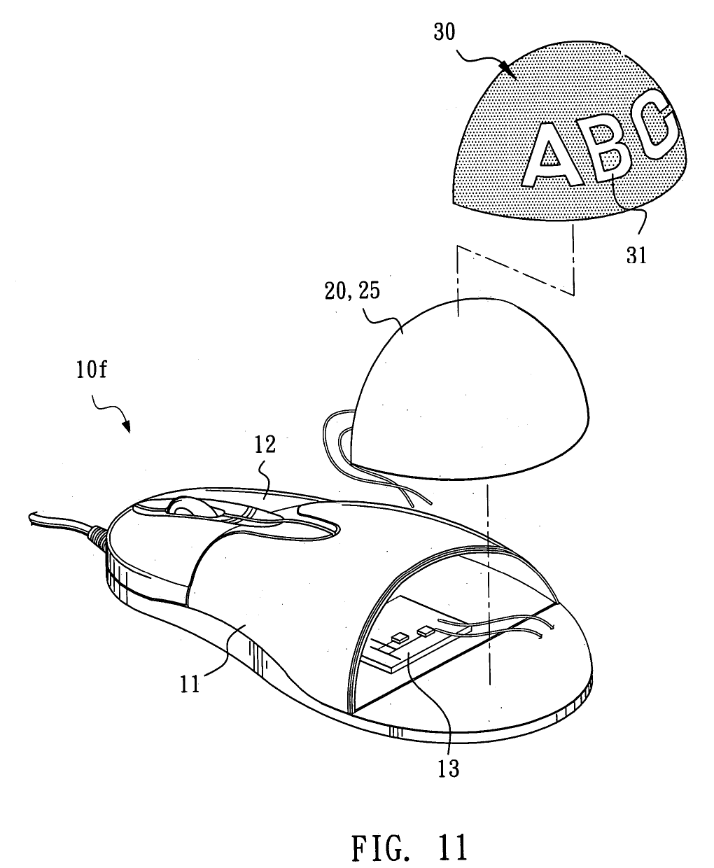

Please refer to FIG. 11. FIG. 11 is a three-dimensional drawing of a seventh embodiment of the present invention, which shows the computer mouse with a luminescent plate and the ornamental housing. In this embodiment, a computer mouse 10f has a luminescent plate 25 to serve as the ornamental light source 20 and the ornamental housing 30 shown in FIG. 2, and so the transparent or translucent area 31 will permit that passage of light.

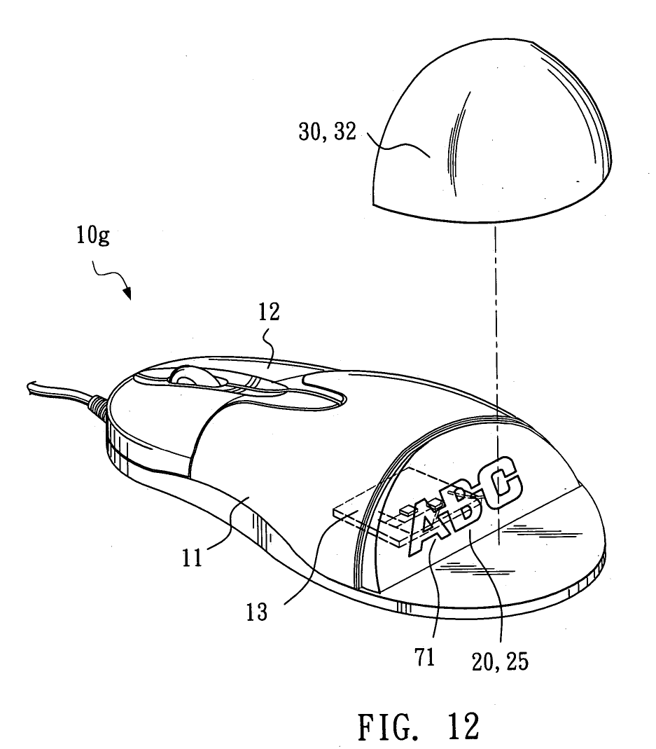

Please refer to FIG. 12. FIG. 12 is a three-dimensional drawing of an eighth embodiment of the present invention, which shows the computer mouse has a luminescent plate. The luminescent plate 25 in the eighth embodiment is in a word or a pattern 71 shape, and a transparent housing 32 (or the ornamental housing 30) to protect the luminescent plate 25.

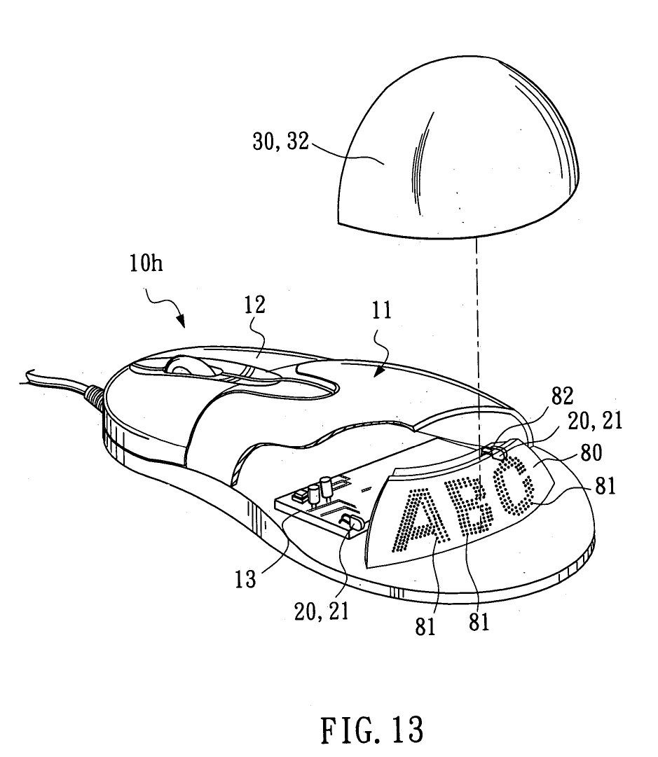

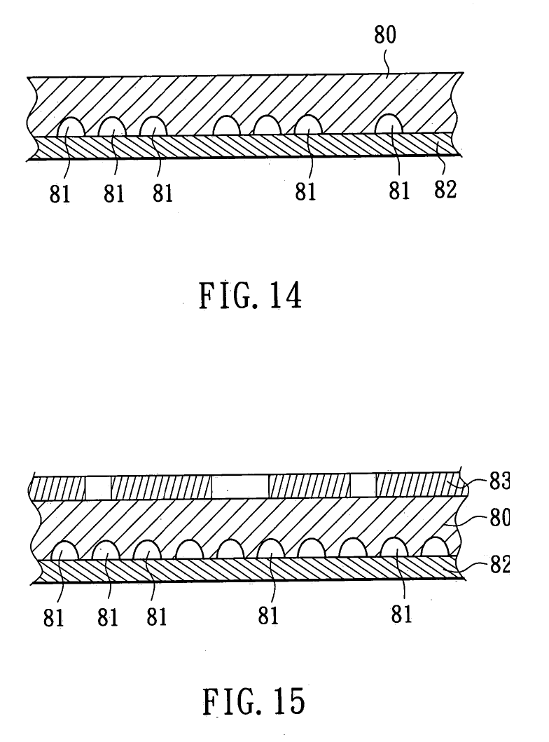

Please refer to FIG. 13˜FIG. 15 for a ninth embodiment of the present invention, which illustrates the word and the pattern displayed on the transparent plate by way of light refraction and focusing. A main characteristic of the ninth embodiment is a transparent plate 80 having a plurality of holes 81 which form a word or a pattern, and a light shield 82 connected to the back of the transparent plate 80. Furthermore, the light source 20 (such the LED 21) is placed along a side of the transparent plate 80, and the plurality of holes 81 receive the light by refraction and then focus the light to display a word or a pattern. Lastly, the ornamental housing 30(or the transparent housing 32) is used to protect the transparent plate 80. Please refer FIG. 15 and note that the plurality of holes 81 on the transparent plate 80 do not have to form a word or a special pattern. The plurality of holes 81 can be arranged regularly (e.g. a matrix pattern) on the transparent plate 80. To display a word, for example ABC, a mask 83 with ABC transparent portion can be placed on the top of the transparent plate 80, so that only ABC is radiate.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

Although the present invention has been explained in relation to its preferred embodiment, it is to be understood that many other possible modifications and variations can be made without departing from the spirit and scope of the invention as hereinafter claimed. For example, the ornamental light source can be attached to a rotary color tray to change light color, and the present invention can be applied to a computer mouse, an optical computer mouse or a wireless mouse.

What is claimed is:

1. A computer mouse comprising a main housing, at least one button mounted on the main housing, an electrical mechanism mounted inside the main housing to provide functionality of the computer mouse, the computer mouse characterized by further comprising an ornamental light source member that is connected with the electrical mechanism for obtaining electrical power, the ornamental light source member transmitting light to produce an ornamental effect for the computer mouse.

2. The computer mouse as claimed in claim 1 further comprising an ornamental housing, the ornamental housing fastened to the main housing and having at least one transparent or translucent area.

3. The computer mouse as claimed in claim 1 further comprising a plurality of optical fibers, each optical fiber having a front end and a back end, wherein the front end of the optical fiber is connected to a light source so that light from the light source is sent to the back end of the optical fiber.

4. The computer mouse as claimed in claim 3 further comprising a cover having a plurality of holes, all or part of the back end of the optical fibers being inserted through the holes of the cover.

5. The computer mouse as claimed in claim 4 wherein the back end of the optical fibers inserted through the holes form a word or a pattern.

6. The computer mouse as claimed in claim 4 wherein the light source has a plurality of alternative lighting characteristics that are capable of forming different characteristics or patterns at different times.

7. The computer mouse as claimed in claim 1 further comprising a liquid decoration connected to the main housing, the liquid decoration comprising a sealed vessel, the sealed vessel having at least one liquid inside and at least one float in the liquid.

8. The computer mouse as claimed in claim 7 wherein a fluorescent material is added into the sealed vessel.

9. The computer mouse as claimed in claim 1. wherein the light source is a light emitting diode (LED).

10. The computer mouse as claimed in claim 1 wherein the light source is a luminescent plate.

11. The computer mouse as claimed in claim 10 further comprising an ornamental housing, the ornamental housing fastened to the main housing and having at least one transparent or translucent area.
The computer mouse as claimed in claim 1 further comprising a transparent plate with a plurality of holes and a light shield connected to the back of the transparent plate.
